(19) United States
(12) Patent Application Publication
(10) Pub. No.: US 2008/0216814 A1
(43) Pub. Date: Sep. 11, 2008

(54) Duel bracket for large or heavy gas grill lids

(76) Inventor: Joseph O'Neill, Nicholson, PA (US)

Correspondence Address: JOSEPH O'NEILL, RR2 2205 PEDRICK RD., NICHOLSON, PA, 18446, US

(21) Appl. No.: 11/818,557

(22) Filed: Jun. 15, 2007

Related U.S. Application Data
(60) Provisional application No. 60/814,194, filed on Jun. 16, 2006.
(60) Provisional application No. 60/813,473, filed on Jun. 15, 2006.

(51) Int. Cl. A47J 37/07; F16M 13/00

(52) U.S. Cl. 126/25 R; 248/354.6

(57) ABSTRACT

The gas grill lid is supported by the duel damper bracket in selected open positions having notches or cutouts to be used for selected openings using a screw, pin or rivot mounted on both sides of the gas grills.

The duel bracket is positioned by a cross member mounted to the inside of the base of the gas grill with a pull handle in the front of the base of the gas grill.

The slot that is in the base of the gas grill is for the movement of the Duel Bracket using the cross member with a pull handle.

### SUMMARY OF INVENTION

The operation of this Duel Bracket for Gas Grills is the lid moves freely up and down when not in use. When said Duel Bracket is to be used just pull the handle provided on the front of the Gas Grill to the desired positions and it locks into place. To release the engaged bracket just lift the lid and the Duel Bracket disengages riding on a screw, pin or rivot on the smooth surface of the inside rail opposite of the hooks or cut outs of the Duel Gas Grill bracket. The only time you need to touch the Duel Gas Grill Bracket Handle is when it is to be used to put the lid into the desired positions.

### DESCRIPTION

1. The Duel Damper Control Assembly is used for large and heavy gas grill lids.

2. This Duel Damper Gas Grill Bracket Assembly consists of a cross member that is mounted behind the rotisserie area with the end of the cross member going thru the slot in the gas grill base and thru the Duel Gas Grill Bracket for the control of the Bracket from both sides of the Gas Grill for engaging.

This slot in both sides of the gas grill base is for the movement of the Duel control Assembly when raising and lowering the lid also when engaging and disengaging the two Damper Brackets.

4. This member the Duel Gas Grill Bracket has an inside opening consisting of a smooth rail and notches or cutouts to be mounted on both sides of a large or heavy gas grill lid. Such member is to be mounted on aprox. angle using the hole and the inside opening to create the angle.

5. This member consists of a thru opening, the inside front consists of a smooth surface and opposite side consists of notches or cutouts for engaging of the bracket to put the lid into different positions for cooking

### BRIEF DESCRIPTION OF THE DRAWINGS

For better understanding of the invention; reference is made to the following drawings which are to be taken in conjunction with the detailed description to follow in which;

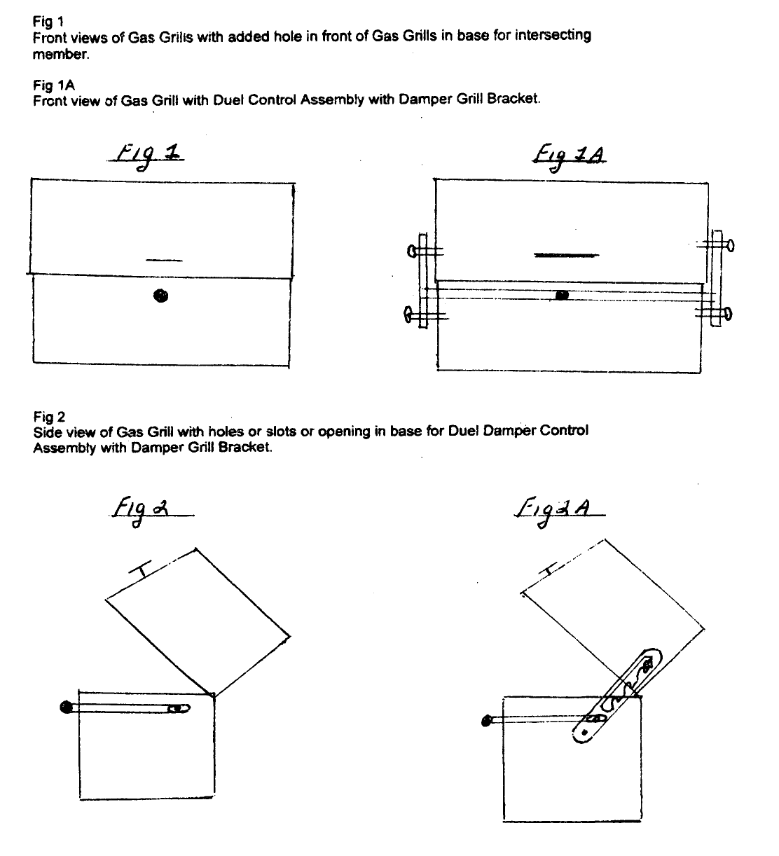

1. Front view of the gas grill with added hole in front of gas grill base for intersecting member VIEW—FIG. 1

2. Front view of gas grill with Duel Control Assembly and Duel Grill Bracket VIEW—FIG.-1A

3. Side view of the gas grill with holes or slots or opening in the base for the Duel Control Assembly, VIEW—FIG. 2

4. Side view of gas grill with grill bracket mounted VIEW—FIG. 2A

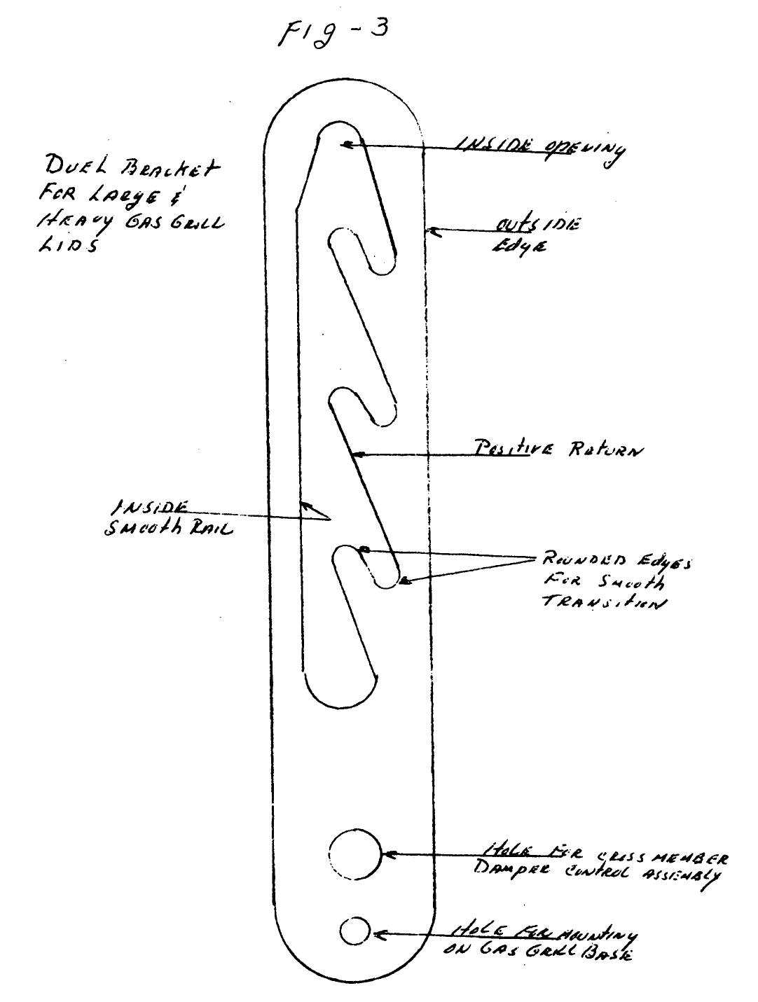

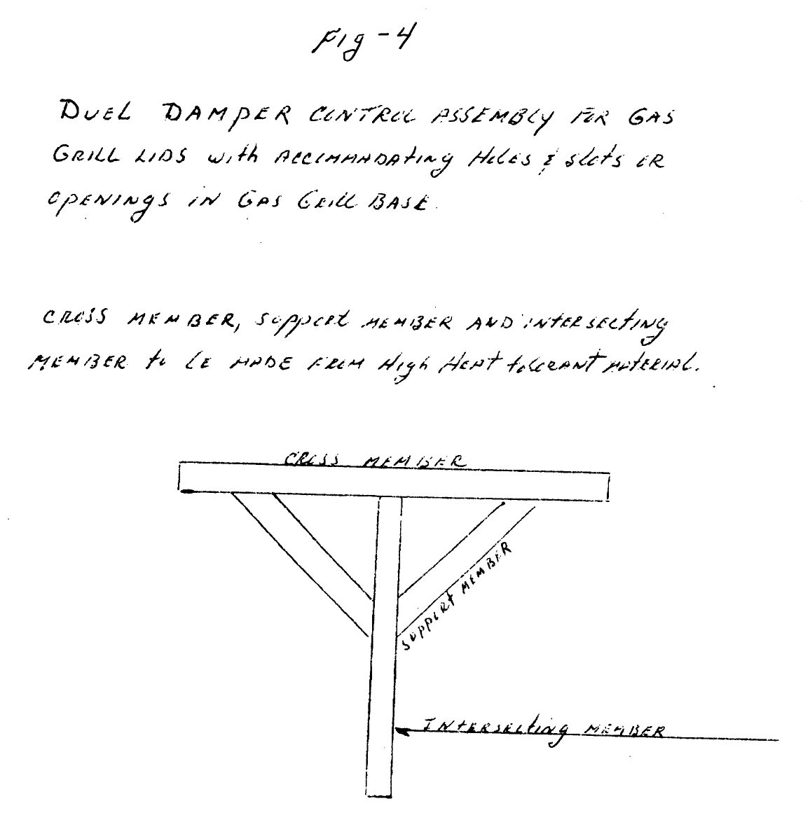

5. Duel Bracket VIEW—FIG. 3 shows the inside opening the out side edge the positive return rail the inside smooth rail the hole for the cross member and the hole for mounting on the gas grill.

6. VIEW—FIG. 4 Duel Damper Control Assembly for gas grill lids. Cross member to be made from high heat tolerant material.

I claim:

1. The Duel Damper Gas Grill Bracket is consisting of a member with a cross member with a pull handle in the front of the base of the gas grill. Consisting of notches or cutouts to put heavy and large gas grill lids in different positions for cooking.

2. As stated in claim 1 said notches or cutouts having a rounded edges for easy transition of Duel Damper Gas Grill Bracket to lock into desired cooking positions.

3. As stated in claim 2 said notches or cutouts are only used when engaging the Duel Damper Gas Grill Bracket.

4. As stated in claim 3 to engage member for desired positions of gas grill lid just pull the provided handle in the front of gas grill base forward and said member engages the gas grill lid into desired positions using the cross member and slot in gas grill base to position the Duel Gas Grill Bracket.

5. As stated in claim 4 said bracket when engaged rides on a screw, pin or rivet to lock heavy or large gas grill lids into position.

6. As stated in claim 5 said duel bracket when engaged rides on a screw, pin or rivot to disengage just lift the lid and said bracket rides on said screw, pin or rivot and when not being used said screw, pin or rivot rides on the smooth inside rail of the dual bracket.
